(19) United States
(12) Patent Application Publication
(10) Pub. No.: US 2009/0094979 A1
(43) Pub. Date: Apr. 16, 2009

(54) Turbocharger with adjustable turbine geometry and a vane carrier ring

(76) Inventors: Werner Eissler, Kernen (DE); Frank Wehinger, Leinfelden-Echterdingen (DE)

Correspondence Address: KLAUS J. BACH, 4407 TWIN OAKS DRIVE, MURRYSVILLE, PA, 15668, US

(21) Appl. No.: 12/288,326

(22) Filed: Oct. 17, 2008

Related U.S. Application Data
(63) Continuation-in-part of application No. PCT/EP2007/003086, filed on Apr. 5, 2007.

(30) Foreign Application Priority Data
Apr. 19, 2006 (DE) 10 2006 018 055.0

(51) Int. Cl. F02D 23/00

(52) U.S. Cl. 60/602

(57) ABSTRACT

In an exhaust gas turbocharger for an internal combustion engine, which comprises a housing with an exhaust gas-conducting section with an inflow passage for directing exhaust gas to a turbine wheel arranged in the exhaust gas-conducting section including a carrier ring with an adjustable guide apparatus having guide vanes arranged on one side of the carrier ring for controlling the flow velocity of the exhaust gas flow to the turbine wheel, the carrier ring has at least one compensating opening extending therethrough so as to provide for pressure compensation between the inflow duct and a rear chamber which is arranged on a side of the carrier ring opposite the guide vanes.

This is a Continuation-In-Part Application of pending International patent application PCT/EP2007/003088 filed Apr. 5,2007 and claiming the priority of German patent application 10 2006 018 055.0 filed Apr. 19, 2006.

### BACKGROUND OF THE INVENTION

The invention relates to an exhaust gas turbocharger with an adjustable turbine geometry including an inlet vane structure and a vane carrier ring.

The document WO 2004/022926 A1 discloses an exhaust gas turbocharger which comprises a housing with an exhaust gas-inlet section and a rotor with a turbine wheel, wherein an adjustable guide apparatus is arranged in the exhaust gas-inlet section. The exhaust gas-inlet section is designed for guiding the exhaust gas, for example of an internal combustion engine of a motor vehicle to the turbine wheel. The exhaust gas can be supplied via an inflow duct to the exhaust gas-inlet section and to the turbine wheel which is arranged in a turbine housing. For varying a flow velocity of the exhaust gas, an adjustable guide apparatus is arranged in the exhaust gas-inlet section, which adjustable guide apparatus comprises a carrier ring and guide vanes which are angularly adjustably mounted thereon. The carrier ring is inserted in the exhaust inlet section so as to be firmly supported therein. The guide vanes are arranged on the carrier ring with a cold clearance, an axial movement of the guide vanes which corresponds to the cold clearance being possible.

It is the object of the present invention to increase the efficiency of an exhaust gas turbocharger and also to increase the service life of the exhaust gas turbocharger, by simple and low-cost measures.

### SUMMARY OF THE INVENTION

In an exhaust gas turbocharger for an internal combustion engine, which comprises a housing with an exhaust gas-conducting section with an inflow passage for directing exhaust gas to a turbine wheel arranged in the exhaust gas-conducting section including a carrier ring with an adjustable guide apparatus having guide vanes arranged on one side of the carrier ring for controlling the flow velocity of the exhaust gas flow to the turbine wheel, the carrier ring has at least one compensating opening extending therethrough so as to provide for pressure compensation between the inflow duct and a rear chamber which is arranged on a side of the carrier ring opposite the guide vanes.

Depending on the operating state of the internal combustion engine, or depending on the velocity of the exhaust gas flow, a higher pressure can prevail in the rear chamber than in the inflow duct.

This pressure difference generates a force in the axial direction on the support shafts of the guide vanes, so that an axial movement of the movably mounted guide vanes occurs as a result of a cold clearance. Thus, the guide vanes are on occasion pressed against an opposite housing wall in an undesired manner. An adjustment movement of the guide vanes then leads to wear-inducing friction between the guide vanes and the housing wall. If, on the other hand, the pressure in the rear chamber is lower than in the inflow passage, in particular under medium and high loads of the internal combustion engine, a force acting in the axial direction is also generated on the guide vane surfaces located opposite the wall, so that the guide vanes are now pressed against the carrier ring. In this case any position adjustment of the guide vanes causes friction between the guide vanes and the carrier ring. Accordingly, increased abrasion again occurs, so that wear of the exhaust gas turbocharger is increased.

Compensation openings in the carrier ring provide for pressure compensation between the inflow duct and the rear chamber so that an axial movement of the guide vanes as a result of the pressure difference can be reduced or completely avoided. On one hand the efficiency of the exhaust gas turbocharger can be increased thereby while, on the other, abrasive as well as adhesive wear of the guide vanes and the housing wall is reduced. Consequently, an increase in the service life of the exhaust gas turbocharger is achieved.

In a configuration wherein the compensating openings extend in the axial direction through the carrier ring, very little manufacturing costs are involved.

In a further configuration, a first distance is provided between a center of the compensation opening and an axis of the carrier ring, which first distance corresponds to a second distance formed between the axis of the carrier ring and an axis of a bearing of the guide vanes. The advantage of this arrangement of the compensation bore is to be seen in a technically simple manufacture of the carrier ring, since the same work process employed for producing the openings of the vane support bores can be utilized. The compensating opening advantageously has a diameter corresponding to that of the vane support bores.

In a further configuration, the carrier ring has on an outer circumference a sealing device by which passage of the exhaust gas from the turbine spiral duct into the chamber upstream of the guide vanes is prevented. All the exhaust gas is therefore conducted by the spiral duct of the turbine via the guide vanes. A further increase in the efficiency of the exhaust gas turbocharger can be brought about thereby.

Further advantages and useful embodiments of the invention will become apparent from the following description thereof of on the basis of the accompanying drawings.

### BRIEF DESCRIPTION OF THE DRAWINGS

FIG. 1 shows in a longitudinal section an exhaust gas-conducting section of an exhaust gas turbocharger with an adjustable guide vane arrangement, and

FIG. 2 shows in a cross sectional view the exhaust gas-conducting section according to FIG. 1 taken along a line II-II.

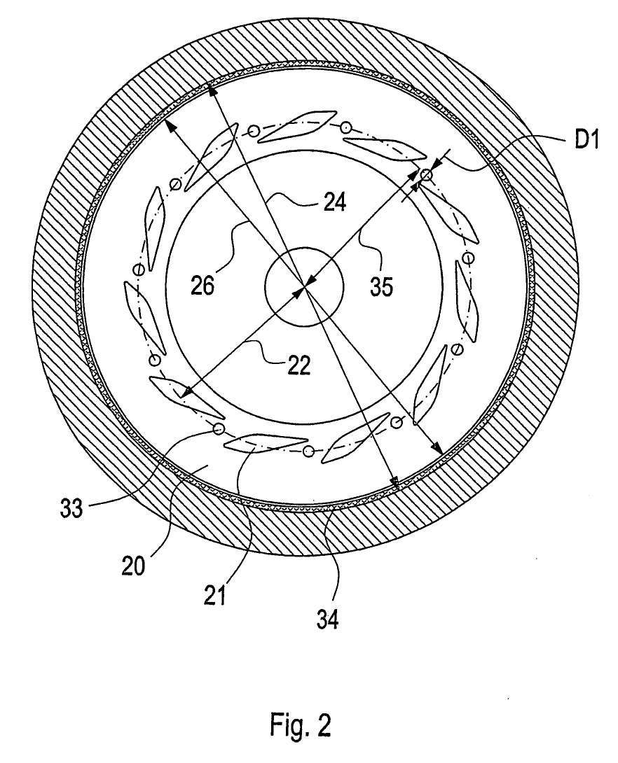

In the figures, all components which are the same, or functionally the same, are provided with the same reference numerals.

### DESCRIPTION OF A PARTICULAR EMBODIMENT OF THE INVENTION

An intake system and an outlet system are associated with an internal combustion engine for a motor vehicle. The internal combustion engine is in the form of a diesel engine. The internal combustion engine has a housing with a cylinder head and a crankcase. Cylinders are arranged in the crankcase, each cylinder having an axially movable piston. In addition, a crankshaft is mounted rotatably in the crankcase. Each piston is connected to the crankshaft by means of a connecting rod, so that relevant piston forces can be transmitted to the crankshaft and converted into a rotary motion of the crankshaft. Combustion chambers for burning an air-fuel mixture are formed in the cylinders of the internal combustion engine. Each combustion chamber is delimited by an inner wall of a cylinder, by the piston being movable in the cylinder and by a wall of the cylinder head, the wall of the cylinder head and the respective piston being arranged approximately opposite one another. The volumes of the combustion chambers can be changed by means of the corresponding pistons, so that a combustion process, known per se, can be performed therein.

The engines cylinder head comprises an intake system with inlet passages and inlet valves, an outlet system with outlet passages and exhaust valves and an injection system for injecting fuel into the associated combustion chambers. Each inlet passage preferably has at least one inlet valve by means of which the inlet passage can be opened and closed, the inlet valve being arranged at an end of the inlet passage oriented towards the combustion chamber. When the inlet valve is open, air or an air-fuel mixture can be supplied to the combustion chamber via the inlet passage. An end of the inlet passage away from the combustion chamber is connected to a manifold chamber which is associated with the intake system and serves to calm the inlet gas flow.

Each outlet passage preferably has at least one exhaust valve by means of which the outlet passage can be opened and closed, the exhaust valve being arranged at an end of the outlet passage at the combustion chamber. As the air-fuel mixture formed in the combustion chamber burns, exhaust gas forms during operation of the internal combustion engine and flows from the combustion chamber into the exhaust system via the outlet passage.

The intake system has a charge air line, the intake manifold being arranged at an end of the charge air line near the internal combustion engine. A charge air cooler for cooling the aspirated air is positioned upstream of the intake manifold in the charge air line. An air filter for cleaning the aspirated air is arranged at the other end of the charge air line, which other end is disposed away from the internal combustion engine.

The exhaust system comprises an exhaust manifold and an exhaust gas line, the exhaust manifold comprising exhaust gas ducts and a collecting duct which joins the exhaust gas passages. The exhaust manifold is arranged downstream of the outlet passages, one exhaust passage being associated with each outlet duct. The exhaust gas line is connected to the exhaust manifold at an opening of the manifold, the opening being positioned at the downstream end of the exhaust gas passages. An exhaust gas treatment system for chemical, thermal and/or mechanical conversion of the exhaust gas is arranged at an end of the exhaust gas line away from the internal combustion engine.

In a supplementary manner, the internal combustion engine has an exhaust gas recirculation system, a connecting line in the form of an exhaust gas recirculation line being arranged between the exhaust manifold and the intake chamber. An exhaust gas cooler for cooling recirculated exhaust gas is arranged in the exhaust gas recirculation line. Control of the recirculated exhaust gas flow is effected by means of an exhaust gas recirculation valve.

A control system is associated with the internal combustion engine, controlling many functions. In particular, the fuel supply and the exhaust gas recirculation valve can be adjusted via the control system.

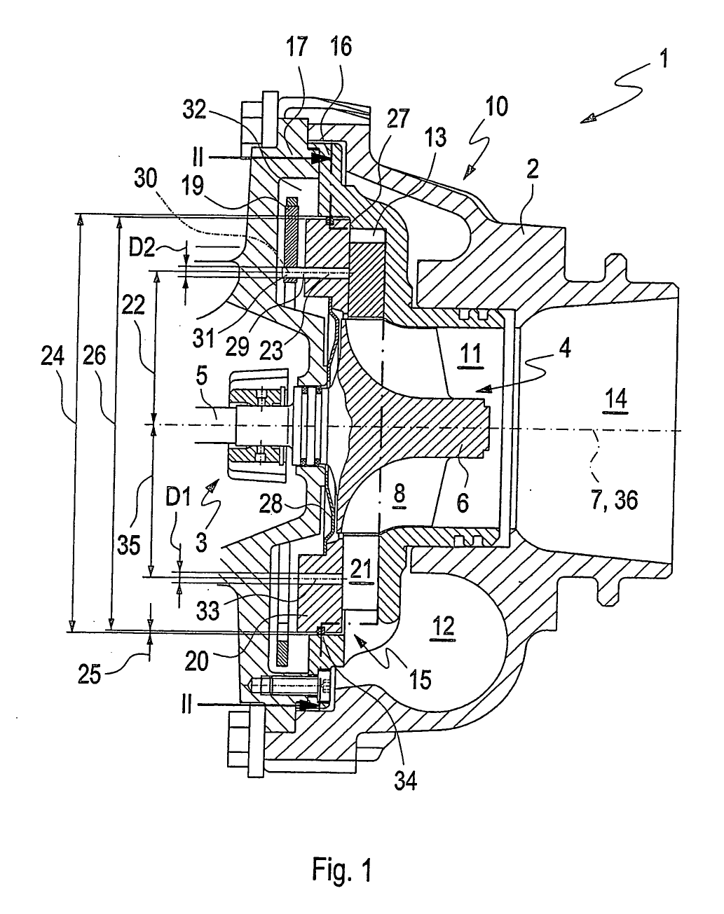

Furthermore, an exhaust gas turbocharger including an exhaust gas turbine 1 for recuperating energy, which comprises a housing 2 and a rotor 3 mounted in the housing 2, is associated with the internal combustion engine. A part of the housing 2, namely an exhaust gas-conducting section 10, is shown in a longitudinal section in FIG. 1.

The rotor 3 comprises a compressor wheel (not shown) for aspirating and compressing air, a radial flow turbine wheel 4 for expanding exhaust gas and a shaft 5 connecting the compressor wheel to the turbine wheel 4 for rotation therewith. The compressor wheel has a first hub with a first axis of rotation and first vanes, the first vanes being fixed rigidly to the first hub. As a rule, the compressor wheel is formed in one piece as a casting. The turbine wheel 4 has a wheel hub 6 with an axis of rotation 7 and vanes 8 fixed to the wheel hub 6. As a rule, the turbine wheel 4 is formed in one piece, in particular of high temperature-resistant materials, since the vanes 8 are exposed to high exhaust gas temperatures during engine operation.

The housing 2 comprises an air conducting section, the air conducting section being positioned in the charge air line in the region of the intake system, and the exhaust gas-conducting section 10, which is arranged in the exhaust gas line in the exhaust system. In addition, the housing 2 has a bearing section in which the shaft 5 is rotatably supported. The bearing section is arranged between the air conducting section and the exhaust gas-conducting section 10.

In the air conducting section, the compressor wheel is rotatably disposed in a first wheel chamber. An inflow duct is arranged in the air conducting section upstream of the first wheel chamber, the inflow duct and the compressor wheel being arranged coaxially. The inflow duct is used for conditioning the air aspirated by the compressor wheel. An inner configuration of an end of the inflow duct which is oriented towards the charge air line has the same shape and size as an inner configuration of the end of the charge air line which is oriented towards the inflow duct. Flow losses of the air upon entering the air conducting section can thereby be avoided. A discharge duct in the form of a diffuser, which is designed to increase the pressure of the air aspirated by the compressor wheel, is formed in the air conducting section downstream of the compressor wheel chamber. A first spiral duct of the air conducting section, which serves to prepare a preferably rotationally symmetrical flow, is connected to the discharge duct at its end away from the wheel chamber. In addition, the spiral outlet duct is configured as a connecting duct between the discharge duct and an outflow duct formed in the air conducting section. The outflow duct has at its end away from the spiral outlet duct an inner diameter equivalent in shape and size to the charge air line, so that flow losses of the compressed air leaving the air conducting section can be avoided.

The air conducting section optionally has a device for guiding the incoming flow toward the compressor wheel. Because of the control of the incoming flow, the aspirated air can be expanded, so that operation of the compressor wheel in a so-called cold-air turbine mode is possible.

An entry duct is formed in the exhaust gas-conducting section for the inflow of exhaust gas into the exhaust gas-conducting section 10. The entry duct serves to control the exhaust gas flow which, during operation of the internal combustion engine, drives the turbine wheel 4 positioned in the exhaust gas-conducting section 10. The entry duct is preferably arranged perpendicularly to the axis of rotation 7 of the turbine wheel 4. A spiral inlet duct 12, which serves to provide for a rotationally symmetrical flow, is connected to the entry duct at its end away from the exhaust gas line. In addition, the spiral duct 12 is in the form of a flow duct between the entry duct and an inlet passage 13 of the exhaust gas-conducting section 10. The inlet passage 13 is positioned downstream of the spiral duct 12, the inlet passage being configured to receive a device which is designed to guide the exhaust gas flow onto the turbine wheel 4.

A second turbine wheel chamber. 11, which receives the turbine wheel 4, is arranged in the exhaust gas-conducting section 10 downstream of the inlet passage 13. An exit duct 14 is positioned in the exhaust gas-conducting section 10 downstream of the second wheel chamber 11. At its end remote from the second wheel chamber 11, the exit duct 14 has an inner diameter equivalent in shape and size to the exhaust gas line, so that the exhaust gas flow from the exhaust gas-conducting section 10 into the exhaust gas line is possible without significant pressure losses.

The exhaust gas-conducting section 10 optionally has a second entry duct which preferably opens into a second turbine spiral duct. In addition, the exhaust gas-conducting section 10 or the exhaust system optionally has a bypass with a waste gate for conducting exhaust gas past the turbine wheel 4 via the bypass by means of the waste gate. A device for a so-called “turbo-braking mode” is optionally also positioned in the exhaust system inside or outside the exhaust gas-conducting section 10, the device being provided to assist a braking operation of the internal combustion engine.

The support section has a bearing device in which the shaft 5 is rotatably supported. For fiction-free rotation of the shaft 5, the bearing section is configured with a conduit system which is designed to receive lubricant. In addition, the bearing section has sealing elements for sealing the air conducting section and the exhaust gas-conducting section 10 against ingress of lubricant. Likewise, the ingress of aspirated air and exhaust gas into the bearing section can be reduced by means of the sealing elements.

During operation of the internal combustion engine, the turbine wheel 4 is driven by the exhaust gas of the internal combustion engine, the speed of the turbine wheel 4 depending on the mass flow and the velocity of an exhaust gas. By way of the shaft 5, the compressor wheel is driven, whereupon air is aspirated and compressed by the compressor wheel.

In order to improve an efficiency of the exhaust gas turbocharger 1, an adjustable guide apparatus 15 is positioned in the exhaust gas-conducting section 10. The direction and velocity of the flow of exhaust gas are adjustable by means of the adjustable guide apparatus 15. The adjustable guide apparatus 15 is arranged in the exhaust gas-conducting section 10 such that the exhaust gas-conducting section 10 is divided into a first partial section 16 and a second partial section 17. Formed between the first partial section 16 and the second partial section 17 is a chamber 32 which receives an adjusting device 19 of the adjustable guide apparatus 15 is disposed. The adjusting device 19 can be adjusted by the control system.

The adjustable guide apparatus 15 comprises a carrier ring 20, guide vanes 21 mounted adjustably on the carrier ring and the adjusting device 19 for adjusting the guide vanes 21. The carrier ring 20 and the turbine wheel 4 are arranged coaxially, the second axis of rotation 7 of the turbine wheel corresponding to a longitudinal axis 36 of the carrier ring 20. The carrier ring 20 has first support openings 23 for receiving a support device of the guide vanes 21 at a first distance 22 from the longitudinal axis 36. The first receiving openings 23 extend axially completely through the carrier ring 20.

The carrier ring 20 is positioned between the first partial section 16 and the second partial section 17. A wall of the first partial section 16 oriented towards the carrier ring 20 has an internal diameter 24, which is larger by a minimal gap 25 than an external diameter 26 of the carrier ring 20.

The first partial section 16 has a shoulder 27 in the region of the carrier ring 20. The shoulder 27 is configured to limit an axial movement of the floatingly mounted carrier ring 20 in the direction of the inflow duct 13, the carrier ring 20 being pressed against the shoulder 27 by means of a spring device 28. The axial movement of the carrier ring 20 in the direction of the chamber 32 is counteracted by means of the spring device 28. The spring device 28 is preferably a disk spring.

The guide vanes 21 are arranged on a side of the carrier ring 20 oriented towards the inflow duct 13 and project into the inflow duct 13. Because thermal deformations can occur during operation of the exhaust gas turbocharger 1, the guide vanes 21 are installed in the inflow duct 13 with a given cold clearance. An axial movement of the guide vanes 21 is possible because of the cold clearance.

The support device of the guide vanes 21 is in the form of a plurality of support shafts 29 associated with the respective guide vanes, the bearing shafts being positioned in the first receiving openings 23. The support shafts 29 each have a third axis of rotation 30. The support shafts 29 are each rotatably supported in a respective second receiving opening 31 of the adjusting device, the bearing shafts being rotatable by means of the adjusting device 19.

A chamber 32, which is separated in a practically pressure-tight manner from the inflow duct 13, is formed between the first partial section 16 and the second partial section 17. Depending on the operating point of the internal combustion engine, a pressure difference is present between a pressure PK in the chamber 32 and a pressure PZ in the in-flow duct 13.

In order to bring about a pressure compensation between the chamber 32 and the inflow duct 13, the carrier ring 20 has compensating openings 33 which extend completely through the carrier ring 20 in the axial direction. The compensating openings 33 advantageously have a diameter Dl which corresponds to a diameter D2 of the first receiving openings 23. In addition, a second distance 35, which is provided between the longitudinal axis 36 and a center of the compensating opening 33, corresponds to the first distance 22. In the present exemplary embodiment a compensating opening 33 is positioned between each two first receiving openings 23.

The axial forces which usually arise in a carrier ring without compensating openings as a result of the pressure difference can therefore be substantially eliminated by the compensating openings 33. Abrasion of the corresponding components, and therefore wear on these components, can be significantly reduced. Furthermore, the compensating openings 33 are simple to produce because of their positioning and the size of their diameter D1.

In addition, the carrier ring 20 has on its outer circumference a sealing device 34 for sealing the inflow duct 13 with respect to the chamber 32. The sealing device 34 is in the form of a sealing ring. An overflow of exhaust gas from the second spiral duct 12 into the chamber 32 upstream of the guide vanes 21 is thereby prevented. A flow of the entire exhaust gas from the second spiral duct 12 via the guide vanes 21 is thereby brought about, whereby an increase in the efficiency of the exhaust gas turbocharger 1 can be achieved.

What is claimed is:

1. An exhaust gas turbocharger for an internal combustion engine, comprising a turbine (1) with a turbine housing (2) having an exhaust gas-conducting section (10) and a rotor (3) with a turbine wheel (4),
the exhaust gas-conducting section (10) including an in-flow passage (13) for directing exhaust gas to the turbine wheel (4) and
an adjustable guide apparatus (15) for controlling the flow of exhaust gas in the exhaust gas inflow passage (13), the adjustable guide apparatus (15) including a carrier ring (20) and guide vanes (21) pivotally supported on one side of the carrier ring (20),
the carrier ring (20) being axially slidably supported in the turbine housing for accommodating thermal expansions and having at least one compensating opening (33) extending therethrough providing for a pressure compensation between the inflow passage (13) and a rear chamber (32) which is arranged on the side of the carrier ring (20) opposite the in-flow duct (13).

2. The exhaust gas turbocharger as claimed in claim 1, wherein the compensating opening (33) extends in an axial direction through the carrier ring (20).

3. The exhaust gas turbocharger as claimed in claim 1, wherein the guide vanes (21) are supported pivotally by shafts (29) disposed at a given distance (22, 35) from the longitudinal axis (36) of the carrier ring (20) and the compensating openings (33) are arranged at the same distance from the longitudinal axis (36) and between adjacent guide vanes (21).

4. The exhaust gas turbocharger as claimed in claim 1, wherein the carrier ring (20) has an outer circumference with a sealing device (34) disposed thereon.

5. The exhaust gas turbocharger as claimed in claim 1, wherein a spring device (28) is disposed between the turbine housing (2) and the carrier ring (20)for counteracting movement of the carrier ring (20) in the direction of the rear chamber (32).

6. An exhaust gas turbocharger for an internal combustion engine, comprising a turbine (1) with a turbine housing (2) having an exhaust gas-conducting section (10) and a rotor (3) with a turbine wheel (4),
the exhaust gas-conducting section (10) including an in-flow passage (13) for directing exhaust gas to the turbine wheel (4) and,
an adjustable guide apparatus (15) for controlling the flow of exhaust gas in the exhaust gas inflow passage (13), the adjustable guide apparatus (15) including a carrier ring (20) axially slidably supported in the turbine housing (2) with guide vanes (21) pivotally supported on one side of the carrier ring (20),
the carrier ring (20) having an outer circumference and a sealing device (34) disposed thereon for sealing the in-flow passage (13) with respect to a rear chamber (32) which is arranged on a side of the carrier ring (20) opposite the inflow duct (13).

7. The exhaust gas turbocharger as claimed in claim 6, wherein the carrier ring (20) has at least one pressure compensating opening (33) extending therethrough providing for a pressure compensation between the inflow duct (13) on one side of the carrier ring (20) and the chamber (32) on the opposite side thereby reducing axial forces forces on the carrier ring (20).

8. The exhaust gas turbocharger as claimed in claim 7, wherein the compensating opening (32) extends in an axial direction through the carrier ring (20).

9. The exhaust gas turbocharger as claimed in claim 7, wherein the guide vanes (21) are supported pivotally by a shaft (29) at a given distance (22, 35) from the longitudinal axis (36) of the carrier ring (20) and the compensating openings (33) are arranged at the same distance from the longitudinal axis (36) and between adjacent guide vanes (21).

10. The exhaust gas turbocharger as claimed in claim 6, wherein a spring device (28) is disposed between the turbine housing (2) and the carrier ring (20)for counteracting movement of the carrier ring (20) in the direction of the rear chamber (32).
